(19) United States
(12) Patent Application Publication
(10) Pub. No.: US 2002/0015880 A1
(43) Pub. Date: Feb. 7, 2002

(54) Molded modular lead-acid battery system

(75) Inventor: Drew Heimer, Lansdale, PA (US)

Correspondence Address: Salvatore J. Abbruzzese, Esq., HOFFMANN & BARON, LLP, 6900 Jericho Turnpike, Syosset, NY, 11791, US

(73) Assignee: C&D Technologies, Inc.

(21) Appl. No.: 09/884,362

(22) Filed: Jun. 18, 2001

Related U.S. Application Data
(60) Provisional application No. 60/212,264, filed on Jun. 19, 2000.

(51) Int. Cl. H01M 2/10

(52) U.S. Cl. 429/97; 429/99; 429/100

(57) ABSTRACT

A sealed-lead acid battery system for standby applications is arranged in a vertically stacked array utilizing molded plastic modules to construct a battery. The modules may support a plurality of battery cells either mounted horizontally (with the plates parallel to module bottom) or vertically (with the plates perpendicular to module bottom). The modules include an interconnecting structure to permit interconnecting vertical stacking of the modules. The structural plastic modules are capable of being stacked several tiers high and withstanding seismic accelerations in accordance with industry seismic codes.

### CROSS-REFERENCE TO RELATED APPLICATIONS:

This application claims priority to U.S. Provisional Application No. 60/212,264, filed Jun. 19, 2000.

### FIELD OF THE INVENTION

This invention relates to lead-acid batteries in general and specifically to variable height racks used to fabricate batteries of differing height therefore differing capacities, while having a common footprint.

### BACKGROUND OF THE INVENTION

Sealed lead-acid cells and other types of batteries are widely used today in commerce for various application. One particular use for such batteries is to provide standby power in the event of a power failure. Stationary batteries are used for standby or operational power in a wide variety of applications including telecommunications utilities, emergency lightings, cable television systems and a number of power supplies. Numerous stationary power applications require anywhere from 6 to 120 cells or even more. In attempting to adequately and efficiently store such number of cells, space consideration must be addressed. There is a need to minimize the floor space occupied by the storage of such cells.

Attempts to minimize the floor space required focus on stacking the batteries vertically. While there exists certain battery racks, cabinets and storage systems which allow for the vertical positioning of batteries, other considerations must be addressed by these storage systems. For example, the batteries must be accessible for periodic testing and the like. The storage system must be cost effective to manufacture and assemble. Due to changing power requirements, the storage system must be designed for flexible re-arrangement. Also, the number and types of cells stored require the address of airflow and high voltage considerations. None of the storage systems currently available provide the flexibility necessary so as to allow various arrangements of vertically stacked batteries to be adequately positioned in minimized floor space.

### SUMMARY OF THE INVENTION

The present invention provides a stackable sealed lead-acid battery system for standby applications characterized by its ease of installation, commonality of components, and bolt-less assembly. Additional benefits over existing art include: lighter weight for handling and floor loading, nonconductive material reducing possibility of battery short, flame retardant material.

The unique racking system may include molded plastic module components (individual bases and side pieces) sufficient in strength to withstand horizontal accelerations per applicable industry seismic codes. The module will be structurally reinforced through a pattern of molded in ribs, cored columns for encapsulating a structural member (such as steel pipe or rod), and other inter-locking means. This constructions would permit assembly with minimal use of installation tools.

The finished module assemblies would encompass airflow slots for directing airflow to control thermal management. A front faceplate, possessing a series of air louvers, would provide air flow and safety measure from contacting live cells. Additionally, the module base includes extrusion profiles to space cells apart and maintain above referenced air flow for maximized thermal management. Custom spacer plates positioned above the cells are designed to restrict movement of cells, provide airflow channel, and maintain compression on cells.

In its broad aspect, the present invention provides a storage system for lead-acid cells of a battery system for stand-by power applications.

More particularly, the present invention provides a stackable modular system which allows the vertical stacking of cells so as to minimize the floor space occupied.

In one embodiment, the present invention provides a stackable module having a molded plastic base and a perimetrical side wall. The base and the wall define an interior compartment for accommodating the cells. The module includes an interconnecting structure for permitting the vertical stackable interconnection of one module to another.

It is further contemplated that the module may be integrally molded of light weight electrically insulative plastic. The side walls and the base may include structural and strengthening ribs. The module permits the accommodation of rods through adjacent modules for releasably confining the modules. Air flow apertures through the side wall assure proper air flow through the module.

In another aspect of the invention, each module preferably includes a generally rectangular horizontal support base with a lip upstanding from and integrally formed with the support base, running along at least one edge of the support base. The lip preferably includes at least one throughbore extending vertically through the lip for receiving a rod or other means for vertically aligning two or more of the stackable housing modules for stacking.

The lip further preferably includes at least one upwardly opening preferably closed bottom receptacle formed in an upwardly facing preferably planar lip surface.

The lip is preferably of first width measured transversely to the support base edge along which the lip extends, where the first width is measured proximate the longitudinal mid-point of the lip. The lip is preferably of greater width measured proximate the longitudinal extremities of the lip.

The preferably closed bottom receptacles are preferably in the first width lip portion and the throughbores are preferably in the second width lip portion, outboard of a longitudinal projection of the first lip portion.

The module further preferably includes at least one side piece adapted for complemental contact along a downwardly facing surface with an upwardly facing surface of the lip. The side piece serves to support a second module resting on the first stackable module. The side piece further includes at least one throughbore extending vertically through the side piece for receiving rods for vertically aligning two or more of the modules for stacking.

The side piece further preferably includes at least one upwardly facing projection member of preferably generally parallelepiped configuration extending from an upwardly facing planar surface of the side piece. The upwardly facing projection member is sized for complementally engaging in downwardly opening closed bottom receptacle in the lip of an overlying one of the modules when the modules are stacked. The side piece of the module further preferably includes a downwardly facing preferably closed bottom projection member of preferably generally parallelepiped configuration and extending from a downwardly facing preferably planar surface of the side piece.

The downwardly facing projection member is sized for essentially complemental engagement with the upwardly opening closed bottom receptacle in the lip of an underlying stackable module when the modules are stacked. The side piece is preferably a first width measured transversely to the base edge along which the complementally contacting lip extends proximate the longitudinal mid point of the side piece. The side piece is preferably of greater width proximate longitudinal extremities of the side piece. The projection members are preferably in the first width side piece portion and the throughbores are preferably in the second width side piece portion, outboard of a longitudinal projection of the first side piece portion.

### BRIEF DESCRIPTION OF THE DRAWINGS

FIGS. 1 and 2 are bottom and top perspective views respectively of the module used in the battery storage system of the present invention.

FIG. 3 is a perspective showing of a pair of modules of FIGS. 1 and 2 stacked in a vertical array.

FIG. 4 is an exploded isometric view of a stackable module manifesting aspects of the invention.

FIG. 5 is an exploded isometric view of a stackable module manifesting aspects of the invention as illustrated in FIG. 4, with dotted lines included to illustrate the position of electrochemical cells supported by the stackable module.

FIG. 6 is an exploded isometric view of three of the stackable modules illustrated in FIG. 4, in position for stacking, for assembly of a molded modular lead-acid battery system.

### DETAILED DESCRIPTION OF THE PREFERRED EMBODIMENTS

The present invention provides a modular system for stacking a plurality of cells of a battery system in a vertical orientation. The modular system of the present invention allows numerous vertical levels of battery orientation so that numerous cells can occupy minimum floor space. The modular system of the present invention is easy to use and securely supports the batteries in the vertical orientation.

As used herein, “cell” denotes an assembly of ajar, a cover, a collection of interleaved lead metal plates resident within the jar and electrolytically coupled one to another for producing voltage potential when sulfuric acid electrolyte is present. “Module” denotes a storage unit for a collection of electrically interconnected cells all positioned at the same height or level relative to grade. “Battery” denotes a collection of electrically interconnected cells which may be supported in one or more modules.

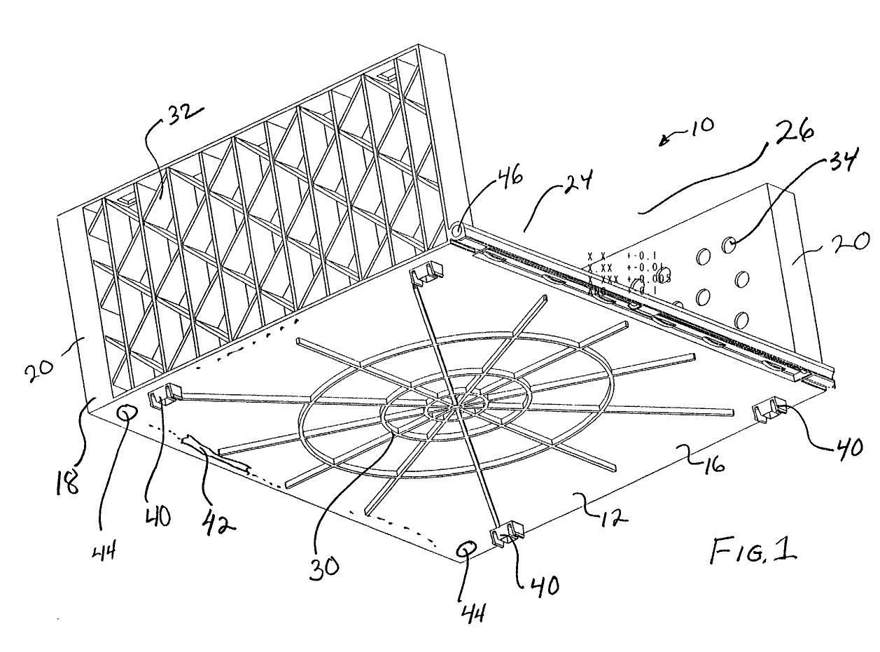

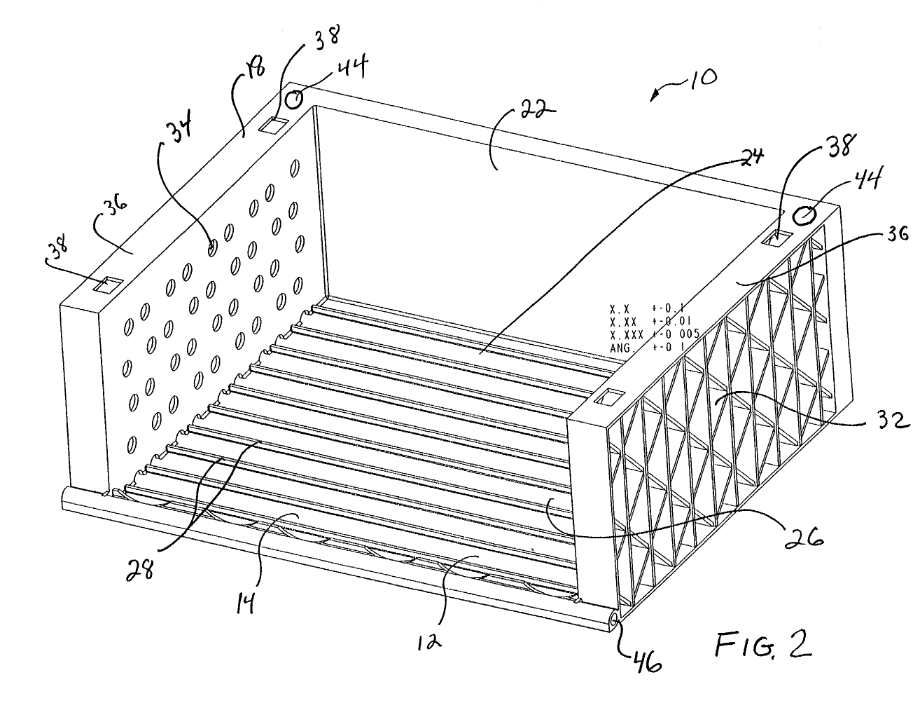

A preferred embodiment of the present invention is shown in FIGS. 1 and 2. The stackable module 10 is generally a rectangular parallelepiped shaped member formed preferably of integrally molded electrically insulative plastic. The plastic may be filled with glass fiber which will improve the strength and moldability of the plastic. Preferably, one type of plastic which may be used in accordance with the present invention is glass filled polypropylene.

Module 10 includes a generally rectangular planar base 12 having an upper surface 14 and opposed lower surface 16. A perimetrical wall 18 extends upwardly from base 12 about three sides thereof. The perimetrical walls defines a pair of spaced apart side walls 20 and a back wall 22 joining side walls 20. The back wall 22 and side walls 20 and base 12 define an interior compartment 24 within module 10 having an open front face 26. The upper surface 14 of base 12 includes a plurality of elongate spaced apart upstanding ribs 28. Ribs 28 provide a support surface for supporting the individual cells within the module so that the cells are raised off of the upper surface 14 of base 12. The position of the ribs and the engagement with the cells provides an area of reduced friction and also permits air flow beneath the cells.

The lower surface 16 of base 12 includes a pattern of strengthening ribs 30 extending therefrom. The strengthening ribs 30 are integrally molded with base 12 and provide structural strength to the base. Each of the side walls 20 of module 10 include a pattern of stiffening ribs 32 formed therein. The stiffening ribs 32 allow for strength to be added to the side walls without the need to increase the amount of plastic used. The stiffening ribs also facilitate injection molding of the module.

The side walls 20 also include a pattern of apertures 34 therethrough. Apertures 34 allow air flow through the side walls which is necessary when the modules support a plurality of battery cells. While not shown in the figures, the back wall 22 may also include both stiffening ribs and air flow apertures as may be required.

In order to facilitate vertical stacking of a plurality of modules 10, the present invention provides interconnection structure for lockingly interconnecting one module in vertically adjacent orientation with another module. Perimetrical wall 18 formed by side walls 20 and back wall 22 includes an upper edge surface 36. Edge surface 36 may include a pair of snap receiving recesses 38 formed therein. In alignment therewith, the lower surface 16 of base 12 may include a plurality of deflectable snaps 40. Deflectable snaps 40 of module 10 may be snap-inserted into the recesses 38 of an adjacent vertically stacked module so as to lockingly support one module vertically above another.

In order to facilitate the structural integrity of the stacked array of modules, the lower surface 16 of base 12 may also include a border rib 42 therearound. Border rib 42 is engageable with edge surface 36 to help stabilize the stacked modules.

In addition, edge surface 36 may include one or more through passages 44. As shown in FIG. 2, through passages 44 may extend vertically through the edge surface and through the side walls 20. When two or more modules are stacked in vertical orientation, a reinforcement rod (not shown) may be extended therethrough to help stabilize the stacked array of modules.

The modules of the present invention may also be used in a horizontally arranged orientation with one module being placed next to another module in side-by-side orientation. In this regard, the base 12 includes a horizontal channel 46 formed adjacent open front face 26. The horizontal channel 46 allows for passage of a reinforcement rod (not shown) through two or more horizontally adjacent modules to stabilize the horizontal arrangement.

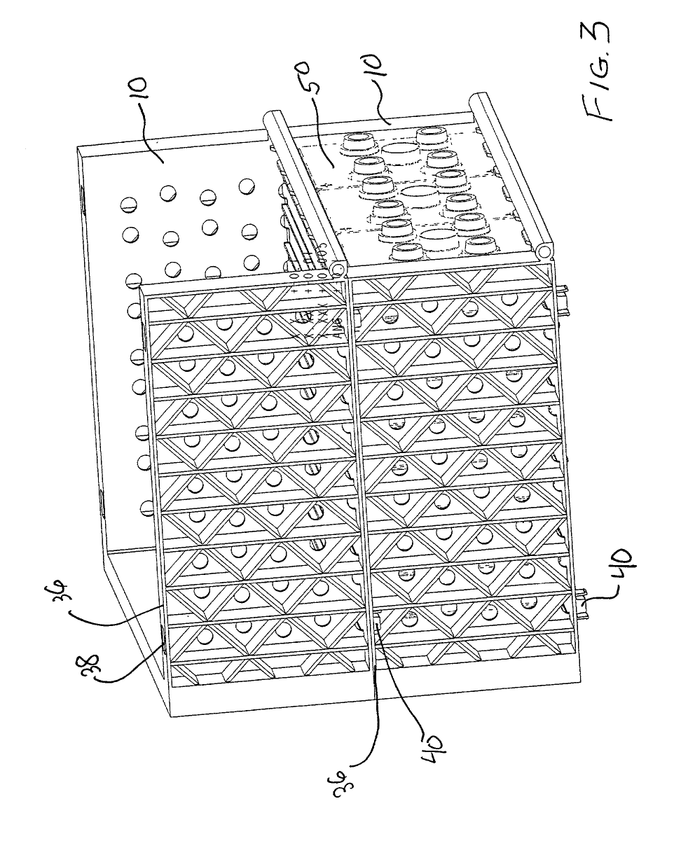

Referring now to FIG. 3, a pair of modules are shown in stacked array. The lower module includes a plurality of cells 50 arranged in horizontal orientation. As can be seen, the snaps 40 of upper module 10 extend through the recesses 38 on the upper edge surface of the lower module 10 so as to lockingly snap together one module to the next. As may be appreciated, a number of modules may be stacked in the same manner. Such arrangement allows a plurality of cells forming a battery system to occupy minimal floor space. The locking interconnection of the modules as well as the use of reinforcement rods help stabilize the array assuring that the array can meet applicable code requirements. Furthermore, the provision for allowing air flow through the stacked array enhances the ability to thermally manage the system. Also, as the modules are formed of electrically insulative plastic, the system provides for reduced shock hazard.

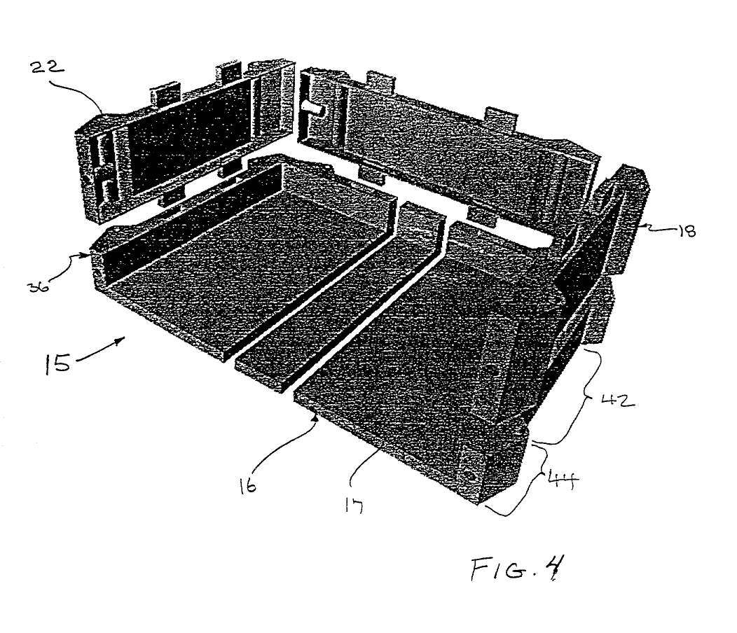

A further embodiment of the present invention is shown in FIGS. 4-6.

Referring to the drawings in general and to FIG. 4 in particular, a stackable module for supporting cells forming part of a battery is designated generally 115 and includes a support base designated generally 116 and at least one side piece, one of which has been designated generally 118.

Support base 116 includes a preferably planar generally rectangular central portion 117 and a lip 136 which is upstanding from and integrally formed with planar central portion 117 to define sides of support base 116. Lip 136 preferably extends along three contiguous edges 138 of planar preferably rectangular central portion 117 and has an area of first width 142 which is generally at the central portion of lip 136 along a given edge 138 and an area of second, greater width 144, which is preferably at relative extremities of lip 136 along a given edge 138, all as illustrated in FIG. 4. As shown in the drawings, the base may be formed of multiple planar portions of differing width interconnected in a snap fit manner.

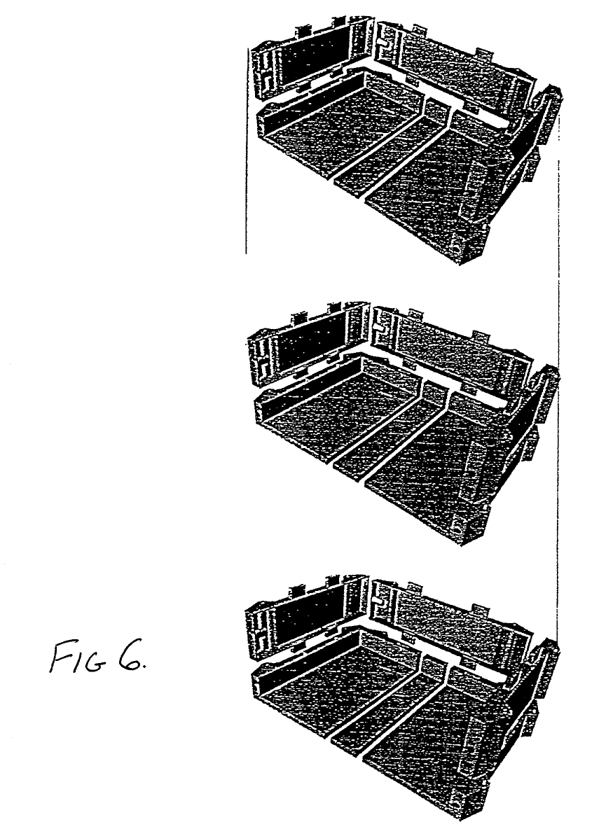

The lip 136 further includes a throughbore extending vertically through the lip for receiving a rod or other means for vertically aligning two or more stackable modules for a stacking purpose. Additionally the lip includes a plurality of upwardly opening closed bottom receptacles formed in an upwardly facing planar surface of the lip. Closed bottom receptacles are preferably formed in the first width lip portion and the throughbores are preferably formed in the second width lip portion outbored of a longitudinal projection of the first lip portion. The module of the present invention further includes a plurality of side pieces having downwardly facing surfaces designed for complimentary engagement with upwardly facing side surfaces of the lip. The side pieces serve to support a second module resting on the first module. The side pieces further include throughbores extending vertically through the side pieces for receiving the rods engageable with the throughbores of the lips for vertically aligning and stacking the modules. The side pieces preferably include upwardly facing projection members. These projection members are preferably generally parallelepiped in configuration and extend from an upwardly facing planar surface of the side piece. The upwardly facing projection members are sized for complimentary insertion into the downwardly open closed bottom receptacles of the lips have been overlying one of the stackable modules. The side pieces, the module further include downwardly facing closed bottom projection members which are also of generally parallelepiped configuration. These downwardly facing projection members extend from a downwardly facing planar surface of the side pieces. The downwardly facing projection members are sized for complimentary insertion into the upwardly opening closed bottom receptacles of the lip of an underlying stackable module. The side pieces preferably include a first width measured transversely to the base edge along which the complimentary contacting lip extends. The side piece is preferably of a greater width proximate to the longitudinal extremities of the side pieces. Thus the width of the side pieces generally corresponds to the width of the lip therealong. The projection members are formed in the first width side piece portion and the throughbores are formed in the second width side piece portion. As is shown in FIG. 6, a plurality of identical modules 115 may be stacked one on top of another in any reasonable desired number so as to accommodate a plurality of cells in vertical orientation thereby minimizing the floor space required to house the batteries.

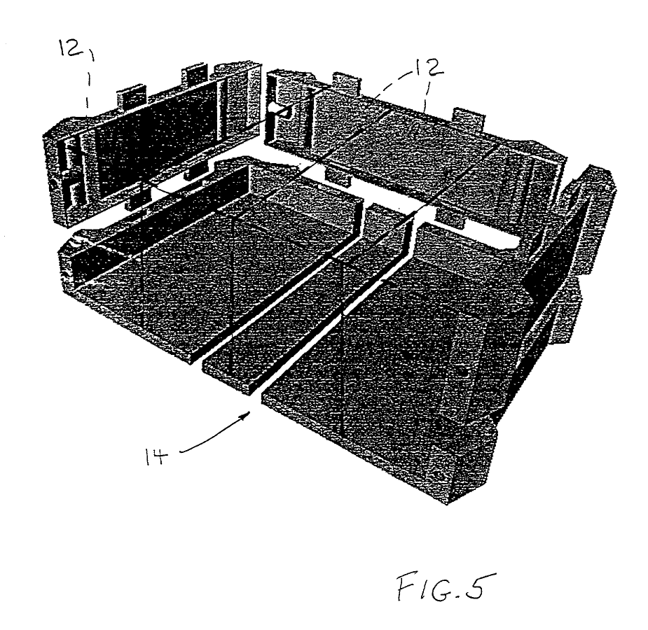

FIG. 5 illustrates in dotted lines the manner in which four or more cells may be supported by the generally rectangular horizontal support base with a lip upstanding from and integrally formed therewith running at least one edge of the support base. As indicated by the dotted lines in FIG. 5, the cells are preferably contiguous one to another supported on the central portion of the base.

Where multiple groupings of cells are to be supported vertically one above another, a plurality of modules may be stacked one upon another with the modules secured in place one over another.

Various changes to the foregoing described and shown structures will now be evident to those skilled in the art. Accordingly, the particularly disclosed scope of the invention is set forth in the following claims.

What is claimed:

1. A stackable member for supporting cells forming a battery comprising:
a molded plastic module having a generally planar base, and a perimetrical wall upstanding from and at least partially surrounding said base, said base and said wall defining an interior compartment for accommodating said cells; and
means for stackably interconnecting one said module to another said module so as to arrange said cells in a vertically stacked array.

2. A stackable member of claim 1 wherein said perimetrical wall includes air flow openings therethrough.

3. A stackable member of claim 1 wherein said base is generally rectangular having an upper battery supporting surface and an opposed lower surface and wherein said perimetrical wall includes a pair of side walls and a back wall between said side walls to define an open front face.

4. A stackable member of claim 3 wherein said upper surface of said base includes a plurality of spaced apart ribs upstanding therefrom for supporting said cells above said upper surface.

5. A stackable member of claim 4 wherein said lower surface of said base includes strengthening ribs.

6. A stackable member of claim 3 wherein said side walls define an upper edge surface and wherein said interconnecting means includes cooperative interconnecting structure on said lower surface of said base and said upper edge surface of said side walls.

7. A stackable module of claim 6 wherein said interconnecting structure includes a deflectable insertable snap formed on one of said lower surface of said base and said upper edge surface of said side walls, and a receptacle for insertably receiving said snap formed on the other of said lower surface of said base and said upper surface of said side walls.

8. A stackable member of claim 6 wherein said lower surface of said base includes a perimetrical rib about the peripheral edge thereof for engagement with said upper edge surface of said side walls for restricting movement between adjacent vertically stacked modules.

9. A stackable member of claim 6 wherein said side walls include an elongate passage extending vertically therethrough for permitting accommodation of an elongate rod through adjacent vertically stacked modules.

10. A stackable module of claim 3 wherein said base includes an elongate horizontal channel extending along the front face of said module for receiving an elongate rod for positionally confining horizontally adjacent modules.

11. A stable module of claim 3 wherein said side wall includes stiffening ribs molded therein.

12. A stable module of claim 11 wherein said stiffening ribs are arranged in a grid-like pattern.

13. A stackable module for supporting cells forming part of a battery, comprising:
a support base comprising:
a generally rectangular horizontal central portion;
a lip upstanding from and integrally formed with said central portion along at least one edge thereof, including at least one throughbore extending vertically therethrough for receiving rod means for vertically aligning two or more of said stackable housing modules for stacking and including at least one upwardly opening closed bottom receptacle formed in an upwardly facing planar surface of said lip;
said lip being of first width measured transversely to said central portion edge along which said lip extends proximate the longitudinal midpoint of said lip and of greater width measured proximate the longitudinal extremities of said lip;
said closed-bottom receptacles being in said first width lip portion and said throughbores being in said second width lip portion and outboard of a longitudinal projection of said first lip portion;
a side piece adapted for complemental contact along a downwardly facing surface thereof with said upwardly facing surface of said lip, for supporting a second module resting on said stackable module including at least one throughbore extending vertically aligning two or more of said stackable housing modules for stacking and comprising:
at least one upwardly facing projection member of generally parallelepiped configuration extending from an upwardly facing planar surface of said side piece and sized for complementally engaging said downwardly opening closed bottom receptacle in said lip of an overlying one of said stackable modules;
said side piece being of first width measured transversely to said base edge along which said complementally contacting lip extends proximate the longitudinal midpoint of said side piece and of greater width proximate the longitudinal extremities of said side piece;
said projection members being in said first width side piece portion and said throughbores being in said second width side piece portion outboard of a longitudinal projection of said first side piece portion.

14. The stackable module of claim 13 wherein said support base comprises a pair of generally rectangular horizontal support base members adapted for abutting contact one with another any symmetrically about a line defined by said abutting contact.

15. The stackable module of claim 14 wherein said support base further comprises an intermediate leaf member adapted for complementally separating said symmetrical rectangular horizontal support base portions.

16. The stackable module of claim 13 wherein said support base further comprises extrusion profiles for spacing apart cells supported by said rectangular horizontal support base.

16. The stackable module of claim 13 wherein said lip extends around three sides of said support base and further comprising three side pieces adapted for complemental contact with said lip along portions of said lip running along said three sides of said support base.

18. A stackable module for supporting cells forming part of a battery, comprising:
a base;
a lip upstanding from said support base, including at least one throughbore for receiving rod means for vertically aligning a plurality of said modules for stacking and including at least one receptacle formed in an upwardly facing surface of said lip;
a side piece adapted for complemental contact along a downwardly facing surface thereof with said upwardly facing surface of said lip, for supporting a second module on said stackable module including at least one throughbore extending therethrough for receiving means for aligning two or more of said modules for stacking and including at least one upwardly projecting member extending upwardly from said side piece and configured for complementally engagement with a downwardly opening receptacle in a lip of an overlying stackable module, and a downwardly projecting member extending from said side piece and sized for complementally engaging an upwardly opening receptacle in a lip of an underlying stackable module.

19. A stackable module of claim 18 wherein said bore is generally a rectangular planar member.

20. A stackable module of claim 19 wherein said lip extends along three sides of said bore.
